(19) United States
(12) Patent Application Publication
(10) Pub. No.: US 2026/0103869 A1
(43) Pub. Date: Apr. 16, 2026

(54) OPERATION SYSTEM AND OPERATION METHOD FOR UNDERWATER JET TRENCHING AND CABLE LAYING

(71) Applicant: CRRC SMD (SHANGHAI), LTD., Shanghai (CN)

(72) Inventors: Dinghua ZHANG, Shanghai (CN); Kean LIU, Shanghai (CN); Yuanyuan GUO, Shanghai (CN); Shaoping TU, Shanghai (CN); Liyang XIANG, Shanghai (CN); Tian CHEN, Shanghai (CN); Zheng WU, Shanghai (CN); Haoyu SUN, Shanghai (CN); Zhonghua ZHANG, Shanghai (CN); Qingqing YUAN, Shanghai (CN)

(21) Appl. No.: 19/421,525

(22) Filed: Dec. 16, 2025

Related U.S. Application Data
(63) Continuation of application No. PCT/CN2024/105972, filed on Jul. 17, 2024.

(30) Foreign Application Priority Data
Dec. 18, 2023 (CN) 202311741653.0

(51) Int. Cl. E02F 5/10; F16L 1/16

(52) U.S. Cl. CPC E02F 5/105; E02F 5/107; E02F 5/108; F16L 1/16

(57) ABSTRACT

The disclosure belongs to the technical field of underwater operations, in particular relates to an operation system and an operation method for underwater jet trenching and cable laying. The underwater walking device is provided at a lower end of the main body; the two jetting arms is located at a front end of the main body; the jetting suction device is arranged at a rear end of the main body and includes a suction pipeline and a second jetting pipe, the suction pipeline is configured to suck sediment in the trench through the suction port before a cable settles to the bottom of the trench and to discharge the sediment to outside of the trench through the discharge port; the second jetting pipe is configured to spray a horizontal jet to scour an inner side wall and the bottom of the trench along the length direction of the trench.

### CROSS-REFERENCE TO RELATED APPLICATIONS

This application is a bypass continuation application of PCT/CN2024/105972 filed Jul. 17, 2024. This application claims priorities from PCT Application No. PCT/CN2024/105972 filed Jul. 17, 2024, and from the Chinese patent application 202311741653.0 filed Dec. 18, 2023, the content of which are incorporated herein in the entirety by reference.

### TECHNICAL FIELD

The disclosure belongs to the technical field of underwater operations, in particular relates to an operation system and an operation method for underwater jet trenching and cable laying.

### BACKGROUND

Currently, in installation of submarine cables, it is required to bury the cables under the seabed, which is with a complicated operation process and requires use of an underwater operation system to move along a direction of the cables pre-laid on the seabed, and to trench on the seabed with an on-board trenching device to make the cables settle to a bottom of a trench so as to ensure that a burial depth meets requirements. For seabed with thin and soft soil, the trenching device is generally a jet trenching device, that is, in which a jetting arm is used to spray jet towards the seabed for trenching. However, for a cable with a large bending radius, such as a cable with a large diameter and high surface hardness, its degree of bending is greatly limited, which generally cannot rely on other auxiliary cable pressing devices when laid, but rely on the cable to naturally settle to the bottom of the trench to ensure that the cable is not crushed in laying. However, in a case of depending on natural settlement of the cable, because a cable laying location is generally in deep sea, the cable is with a large underwater buoyancy and with a relatively slow natural settlement speed, especially in a case of the cable with the large bending radius or a deep trench, a distance for the cable to settle from the seabed to the bottom of the trench is large, and for the seabed with largely thin and soft soil, sediment on the seabed is easy to naturally backfill the trench by ocean currents, and both sides of the trench are easy to collapse and slide down to backfill at the bottom of the trench, resulting in a problem of a depth of the trench being reduced before the cable completely settle to the bottom of the trench, and thus causing a final burial depth of the cable to be not qualified.

### SUMMARY

A technical problem to be solved by the disclosure is to provide an operation system and an operation method for underwater jet trenching and cable laying which can be applied to seabed with thin and soft soil and can ensure a cable to be laid to a target depth under a condition that the cable has a large bending radius and can only naturally settle.

An operation system for underwater jet trenching and cable laying is provided in the disclosure, which includes:
a main body;
a underwater walking device provided at a lower end of the main body;
a jetting soil-breaking device including two jetting arms, the two jetting arms being located at a front end of the main body and are each provided with a front nozzle for spraying a jet to trench on seabed; a jetting suction device provided at a rear end of the main body and including a suction pipeline and a second jetting pipe. The suction pipeline is provided with a discharge port and a suction port, and the suction port is configured to be towards a bottom of a trench, and a position of the discharge port is higher than a position of the suction port and the discharge port is transversely arranged relative to the suction port, and the suction pipeline is configured to suck sediment in the trench through the suction port before a cable settles to the bottom of the trench, and to discharge the sediment to outside of the trench through the discharge port.

The second jetting pipe is located at a rear side of the suction pipeline, and is provided with a jetting port, a jetting direction of the jetting port is horizontally arranged in a direction away from the suction pipeline, and the second jetting pipe is configured to spray a horizontal jet through the jetting port to scour an inner side wall and the bottom of the trench along the length direction of the trench after the sediment in the trench is sucked by the suction pipeline, so as to maintain a shape of the trench when the cable settles to the bottom of the trench.

Furthermore, the jetting soil-breaking device further includes a first laying mechanism. The first laying mechanism includes a fixed pipeline, a rotating pipeline, a first driving mechanism and a second driving mechanism, the fixed pipeline is fixed with the main body, and the rotating pipeline is rotatably arranged on and communicated with the fixed pipeline, the first driving mechanism is configured to drive the rotating pipeline to rotate around the fixed pipeline, the two spraying arms are rotatably arranged on and communicated with the rotating pipeline; and the second driving mechanism is configured to drive the two spraying arms to rotate around the rotating pipeline.

Furthermore, the jetting soil-breaking device further includes a third driving mechanism, and the third driving mechanism can drive the two jetting arms to move along an axial direction of the rotating pipeline to adjust a distance between the two jetting arms.

Furthermore, there are two suction pipelines arranged at an interval along a width direction of the main body, and a distance between the two suction pipelines is adjustable, and there are two second jetting pipes arranged at an interval along the width direction of the main body, and a distance between the two jetting pipes is adjustable.

Furthermore, the jetting suction device further includes a second laying mechanism, a support seat and a first driving assembly. The second laying mechanism is arranged at the rear end of the main body, the support seat is arranged at an end of the second laying mechanism away from the main body, a single one of the second jetting pipes is fixedly connected with a single suction pipeline, and the single one of the second jetting pipes and the suction pipeline fixedly connected therewith form a jetting suction assembly, two jetting suction assemblies are arranged on the support seat and are arranged at an interval, and the cable can fall into the trench along a space between the two jetting suction assemblies.

At least one of the two jetting suction assemblies is slidably arranged on the support seat, and the first driving assembly drives the slidably arranged jetting suction assembly to move so as to adjust a distance between the two jetting suction assemblies.

Furthermore, bottoms of the two jetting arms are each provided with a tail nozzle, and a jetting direction of the tail nozzle is set away from a jetting direction of the front nozzle.

Furthermore, laying heights of the two jetting arms and the two jetting suction assemblies are adjustable.

Furthermore, one end of the suction pipeline is provided with a first water inlet, the other end of the suction pipeline is transversely arranged, and the discharge port is located at the transversely arranged end; a pipe diameter contraction section is provided between the first water inlet and the discharge port on the suction pipeline, an extension pipe is longitudinally extended on a side surface of the pipe diameter contraction section, the suction port is located on the extension pipe; an end cover is provided on the suction pipeline at a position of the discharge port; and an opening and closing degree between the end cover and the discharge port is adjustable.

Furthermore, the operation system further includes a lead jetting mechanism. The lead jetting mechanism is arranged at the front end of the main body and in front of the two jetting arms, and the lead jetting mechanism is provided with a lead nozzle to purge and/or pre-trench the seabed before the two jetting arms operate.

An operation method for underwater jet trenching and cable laying is provided in the disclosure, which uses the operation system for underwater jet trenching and cable laying, and the operation method includes:
S1, enabling the operation system for underwater jet trenching and cable laying to settle on seabed to be trenched and buried with a cable, and enabling projections of the two jetting arms on the seabed to be positioned at two sides of the cable correspondingly;
S2, walking the operation system for underwater jet trenching and cable laying on the seabed along a length direction of the cable through the underwater walking device, and spraying jets through front nozzles on the two jetting arms to jet and soil-break the seabed along the length direction of the cable to trench; and
S3, sucking the sediment in the trench through the suction port of the suction pipeline before the cable falls into the trench, and discharging the sediment to outside of the trench through the discharge port, and spraying a horizontal jet through the jetting port to scour an inner side wall and a bottom of the trench along a length direction of the trench, so as to continuously liquefy soil in the trench and maintain a shape of the trench, and settling the cable naturally to the bottom of the trench.

The disclosure has beneficial effects that for a cable with a large bending radius, a distance for the cable to settle from the seabed to the bottom of the trench is long, and the jetting suction device is arranged outside the rear end of the main body, so that a distance between the jetting suction device and the two jetting arms is large so as to be adapted to a natural settlement amplitude of the cable. The underwater walking device drives the whole operation system to move along the length direction of the cable on the seabed, and the two jetting arms spray water flows to soil-break and trench on the seabed to form the trench. If the soil is thin and soft, the trench is easy to collapse in a short time after soil-breaking and trenching. By arranging jetting suction device at the rear end of the main body, after trenching and before the cable settles to the bottom of the trench, sediment deposited at the bottom of the trench due to natural backflow and collapsing at the two sides are extracted through the suction pipeline, and the extracted sediment is discharged to the outside of the trench to guarantee a depth of the trench, and after the suction pipeline sucks the sediment, the cable continuously settles. The second jetting pipes are used to continuously generate the horizontal jet in the trench along the length direction of the trench to scour the inner side wall and the bottom of the trench, thus continuously liquefying the soil, maintaining the shape of the trench when the cable settles to the bottom of the trench, guaranteeing the depth of the trench, guaranteeing a laying depth to meet operation requirements, and improving safety and stability of the cable after being buried in the seabed. This ensures that a burial depth of the cable can meet the operation requirements and improve the safety and stability of the cable after being buried on the seabed.

In the disclosure, on one hand, the sediment deposited at the bottom of the trench is discharged out of both sides of the trench after the jetting soil-breaking device trenches and before the cable completely settles on the bottom of the trench, and the shape of the trench is continuously maintained using the two jetting ports, so as to ensure that the naturally settling cable can fall on the bottom of the trench; and on the other hand, the sediment discharged by suction is discharged to the outside of the trench and backfilled into the trench for a second time under action of subsequent ocean currents, and for a cable with a large diameter and a deep trench, it can be beneficial to bury the cable by natural ocean currents after the cable settles to the bottom of the trench, so as to ensure that the cable may not be exposed, and improve reliability of underwater cable burying operations.

### BRIEF DESCRIPTION OF THE FIGURES

FIG. 1 is a schematic structural view of an operation system for underwater jet trenching and cable laying in a first operation posture according to the disclosure.

FIG. 2 is a schematic structural view of an operation system for underwater jet trenching and cable laying in a second operation posture according to the disclosure.

FIG. 3 is a schematic structural view of an underwater walking device according to the disclosure.

FIG. 4 is a schematic structural view of a rotatable propeller in an underwater walking device according to the disclosure.

FIG. 5 is a structural schematic view of a track mechanism in an underwater walking device in a first arrangement mode according to the disclosure.

FIG. 6 is a structural schematic view of a track mechanism in an underwater walking device in a second arrangement mode according to the disclosure.

FIG. 7 is a schematic view of a track module in an underwater walking device in a downward inclined posture according to the disclosure.

FIG. 8 is a schematic structural view of a jetting soil-breaking device according to the disclosure.

FIG. 9 is a schematic view of a jetting soil-breaking device in a first lowering posture according to the disclosure.

FIG. 10 is a left side view of FIG. 9 according to the disclosure.

FIG. 11 is a schematic view of FIG. 9 after a distance between two jetting arms is increased according to the disclosure.

FIG. 12 is a schematic view of a jetting soil-breaking device in a second lowering posture according to the disclosure.

FIG. 13 is a schematic view of a jetting soil-breaking device in a recovery posture according to the disclosure.

FIG. 14 is a schematic structural view of a lead jetting mechanism according to the disclosure.

FIG. 15 is a schematic structural view of a jetting suction device according to the disclosure from a first perspective.

FIG. 16 is a schematic structural view of a jetting suction device according to the disclosure from a second perspective.

FIG. 17 is a schematic view of a jetting suction device in a recovery posture according to the disclosure.

FIG. 18 is a schematic view of a jetting suction device in a lowering posture according to the disclosure.

FIG. 19 is a schematic view of a jetting suction device in a left-swing posture according to the disclosure.

Reference numbers are as follows: 1. Main Body; 2. Underwater Walking Device; 21. Sliding Shoe; 22. Track Mechanism; 221. Track Module; 23. First Driving Module; 24. Linkage; 25. Vertical Propeller; 26. Horizontal Propeller; 27. Rotatable Propeller; 271. Connecting Rod; 272. Propeller Body; 28. Second Driving Module; 3. Jetting Soil-breaking Device; 31. Fixed Pipeline; 32. Rotating Pipeline; 321. Elbow; 322. Installation Rod; 33. First Driving Mechanism; 34. Jetting Arm; 341. First Jetting Pipe; 3411. Front Nozzle; 3412. Inner Nozzle; 3413. Tail Nozzle; 35. Guiding Member; 351. Guiding Plug; 352. Connecting Sleeve; 36. Second Driving Mechanism; 37. Third Driving Mechanism; 38. Water Pump Mechanism; 4. Jetting Suction Device; 41. Support Seat; 42. Suction Pipeline; 421. First Water Inlet; 422. Discharge Port; 423. Suction Port; 424. End Cover; 43, Second Jetting Pipe; 431. Second Water Inlet; 432 Jetting Port; 44. First Driving Assembly; 45. Second Driving Assembly; 46. Fixed Frame; 461. Hinge Part; 47. Movable Frame; 48. Third Driving Assembly; 49. Fourth Driving Assembly; 5. Lead Jetting Mechanism; 51. Support Pipe; 52. Lead Jetting Pipe; 51. Front Nozzle; 53. Fifth Driving Assembly; 100. Cable.

### DETAILED DESCRIPTION

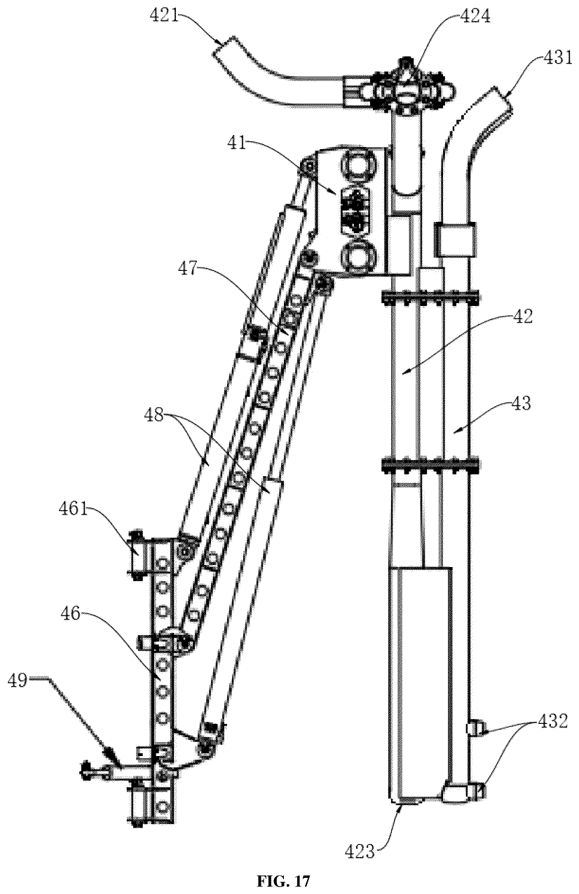

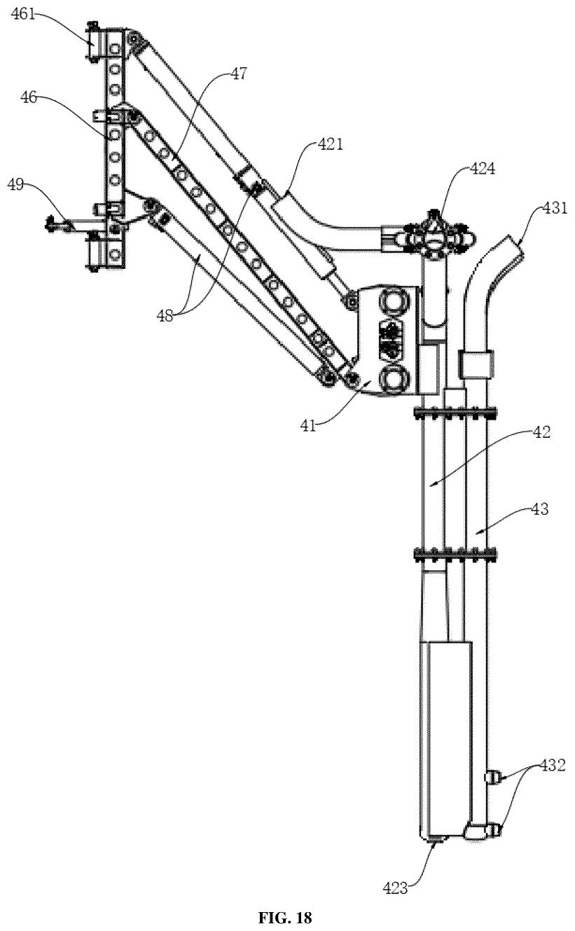

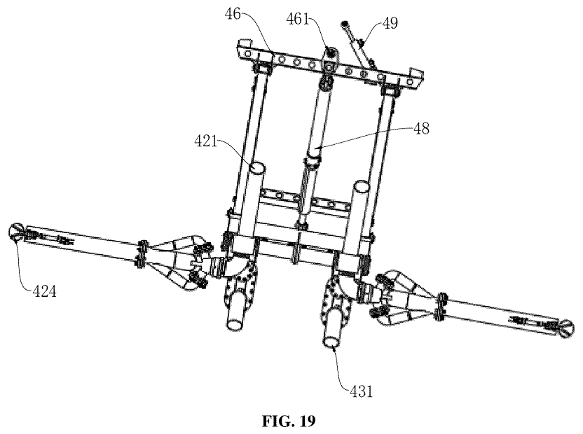

As shown in FIGS. 1 to 19, an operation system for underwater jet trenching and cable laying is provided in the disclosure, which includes a main body 1, an underwater walking device 2, a jetting soil-breaking device 3 and a jetting suction device 4. The underwater walking device 2 is arranged at a lower end of the main body 1 and configured to drive the operation system for underwater jet trenching and cable laying to move on seabed. The soil-breaking device 3 includes a first laying mechanism and two jetting arms 34. The first laying mechanism is arranged on the main body 1, and the two jetting arms 34 are arranged on the first laying mechanism and located at a front end of the main body 1, and are each provided with a front nozzle 3411 for spraying a jet to trench on the seabed.

The jetting suction device 4 is arranged at a rear end of the main body 1 and includes a suction pipeline 42 and a second jetting pipe 43. The suction pipeline 42 is provided with a discharge port 422 and a suction port 423, and the suction port 423 is configured to be towards a bottom of a trench, and a position of the discharge port 422 is higher than a position of the suction port 423 and the discharge port is transversely arranged relative to the suction port 423. In a trenching and cable laying operation, the suction pipeline 42 operates after the jetting arm and is configured to suck sediment in the trench through the suction port 423 before the cable settles to the bottom of the trench, and to discharge the sediment to outside of the trench through the discharge port 422 to ensure that a depth of the trench meets laying requirements. Specifically, height difference between the discharge port 422 and the suction port 423 is greater than the depth of the trench desired to be opened, so that after an end of the suction pipeline provided with the suction port 423 extends into the trench, the discharge port 422 is above and at a side of the trench, and when the suction port 423 sucks the sediment at the bottom of the trench, the sediment is discharged above and at the side of the trench to ensure effective extraction of the sediment in the trench.

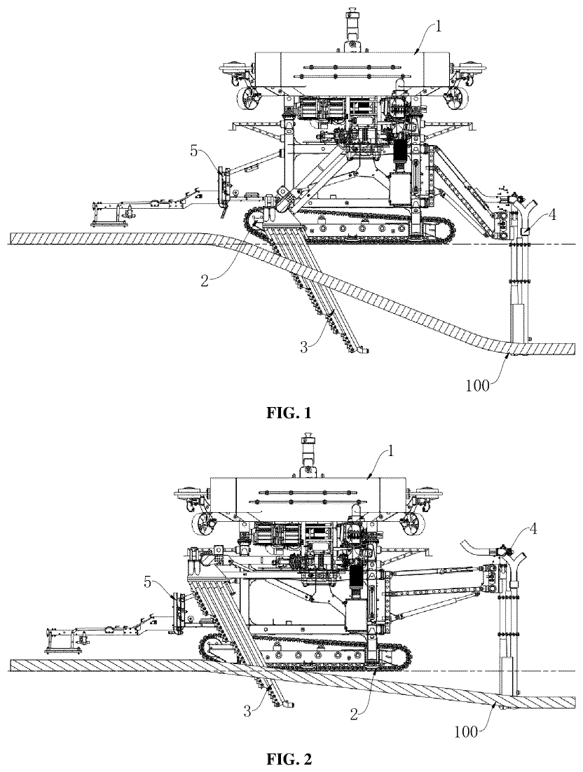

The second jetting pipe 43 is located at a rear side of the suction pipeline 42, and is provided with a jetting port 432, a jetting direction of the jetting port 432 is horizontally arranged in a direction away from the suction pipeline 42. When in use, an end of the second jetting pipe 43 provided with the jetting port 432 extends into the trench, and with movement of the main body 1 in trenching, the jetting port 432 can spray a horizontal jet in a direction towards a rear side of the main body 1 along a length direction of the trench, and thus the second jetting pipe 43 is used to spray the horizontal jet to scour an inner side wall and the bottom of the trench along the length direction of the trench after the sediment in the trench is sucked by the suction pipeline 42, so as to continuously liquefy the soil, maintain a shape of the trench when the cable settles to the bottom of the trench, and ensure that a settling depth of the cable meets operation requirements when the cable falls to the bottom of the trench. As shown in FIGS. 1 and 2, for a cable 100 with a large bending radius, a distance for the cable to settle from the seabed to the bottom of the trench is long, and by arranging the jetting suction device outside the rear end of the main body 1, a large distance between the jetting suction device and the two jetting arms 34 is large so as to be adapted to a natural settlement amplitude of the cable 100. The underwater walking device 2 drives the whole operation system to move along the length direction of the cable 100 on the seabed, and the two jetting arms 34 spray water flows to soil-break and trench on the seabed to form the trench, which is more suitable for the seabed with thin and soft soil than a mechanical cutting soil-breaking device. If the soil is thin and soft, the trench is easy to collapse in a short time after soil-breaking and trenching. By arranging jetting suction device 4 at the rear end of the main body 1, after trenching and before the cable settles to the bottom of the trench, sediment deposited at the bottom of the trench due to natural backflow and collapsing at the two sides are extracted through the suction pipeline 42, and the extracted sediment is discharged to the outside of the trench to guarantee a depth of the trench, and after the suction pipeline 42 sucks the sediment, the cable continuously settles. The second jetting pipes 43 are used to continuously generate the horizontal jet in the trench along the length direction of the trench to scour the inner side wall and the bottom of the trench, thus continuously liquefying the soil, maintaining the shape of the trench when the cable settles to the bottom of the trench, guaranteeing the depth of the trench, guaranteeing a laying depth to meet operation requirements, and improving safety and stability of the cable after being buried in the seabed. In the disclosure, on one hand, the sediment deposited at the bottom of the trench is discharged out of both sides of the trench after the jetting soil-breaking device 3 trenches and before the cable completely settles on the bottom of the trench, and the shape of the trench is continuously maintained using the two jetting ports 432, so as to ensure that the naturally settling cable 100 can fall on the bottom of the trench; and on the other hand, the sediment discharged by suction is discharged to the two sides of the trench and backfilled into the trench for a second time under action of subsequent ocean currents, and for a cable 100 with a large diameter and a deep trench, the cable 100 can be buried by natural ocean currents after the cable 100 settles to the bottom of the trench, so as to ensure that the cable 100 may not be exposed, and improve reliability of underwater cable burying operations.

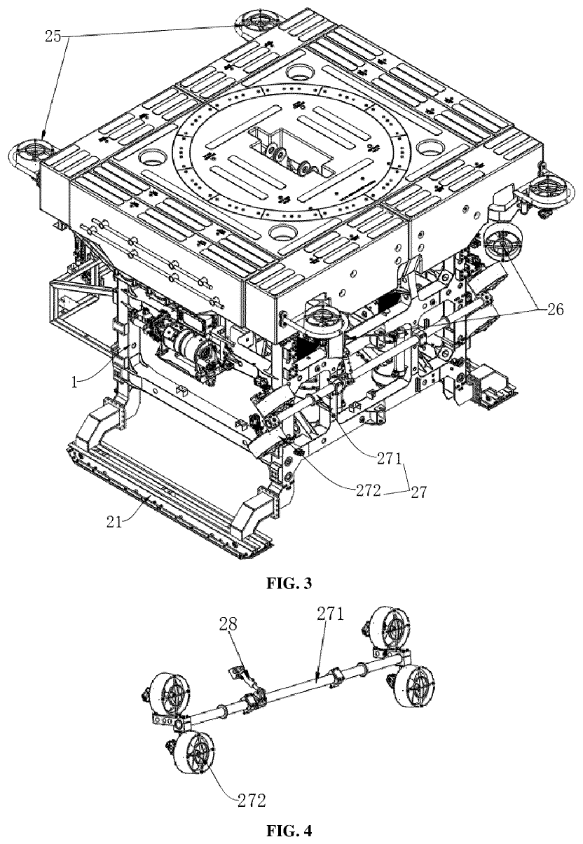

The underwater walking device includes a walking mechanism and a propulsion mechanism, and the propulsion mechanism is arranged on the main body 1 and configured to generate a thrust and assist in movement and posture adjustment of the underwater walking device. There are two walking mechanisms, which are located on both sides of the main body 1 correspondingly, that is, one of the two walking mechanisms is located on one side of the main body 1 and the other of the two walking mechanisms is located on the other side of the main body 1, and the walking mechanism is connected with the main body 1. In an embodiment of the disclosure, as shown in FIG. 3, the walking device is a sliding shoe 21, and the sliding shoe 21 is fixedly connected with the main body 1. With the thrust generated by the propulsion mechanism, the operation system can slide on the seabed. Compared with a track mechanism, the sliding shoe 21 is simple in structure and light in weight, which can reduce overall underwater weight of the operation system and is suitable for operating on soft soil which is easy to collapse.

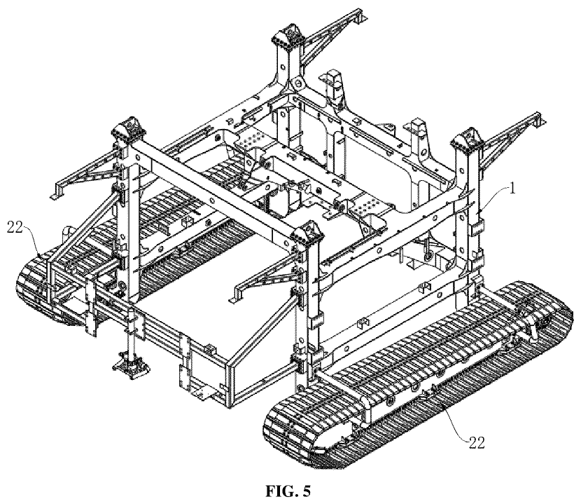

In another embodiment of the disclosure, as shown in FIGS. 5 to 7, the walking mechanism is a track mechanism 22, which is connected with the main body 1 in a hinged manner, and both track mechanisms 22 each have a moving stroke inclined relative to the main body 1, that is, postures of the track mechanisms 22 on the main body 1 are adjustable. Driving mechanisms are correspondingly provided on both sides of the main body 1, for respectively driving the track mechanisms 22 located on both sides of the main body 1 to move, so as to adjust the postures of the track mechanisms 22, thereby adjusting inclination of the track mechanisms 22 relative to the main body 1 and adjusting an included angle between bottoms of the two track mechanisms 22.

For the underwater walking device provided in the disclosure and in an embodiment based on the track mechanism 22, the inclination of the track mechanism 22 relative to the main body 1 and the included angle between the bottoms of the two track mechanisms 22 can be adjusted by adjusting the postures of the track mechanisms 22, so that bottom surfaces of the two track mechanisms 22 can be on a same horizontal plane to be adapted to walking on gentle seabed, or the bottom surfaces of the two track mechanisms 22 form an upward or downward included angle so as to be adapted to seabed with a ridge-shaped protrusion or a groove-shaped downward depression, and grasping ability and underwater walking performance of the track mechanism 22 can be improved on such seabed terrain. A posture of the device according to the disclosure can be adjusted and an auxiliary thrust can be provided by the propulsion mechanism, and combined with the thrust of the track mechanisms 22 in operation, thrust requirement of walking on the seabed with thin and soft soil can be met, thus avoid slipping, further improving the underwater walking performance, meeting walking requirements and reliability for different underwater terrain, improving flexibility of underwater operations, and broadening a range of operational scenes. As shown in FIG. 7, the postures of the two track mechanisms 22 are adjusted to be adapted to the seabed with the groove-shaped downward depression, and when the two track mechanisms are used to be adapted to the seabed with the ridge-shaped protrusion, the two track mechanisms 22 are inclined downward.

In an implementation of the disclosure, as shown in FIG. 5, a single track mechanism 22 is one track mechanism, that is, only one track mechanism is arranged on one side of the main body 1.

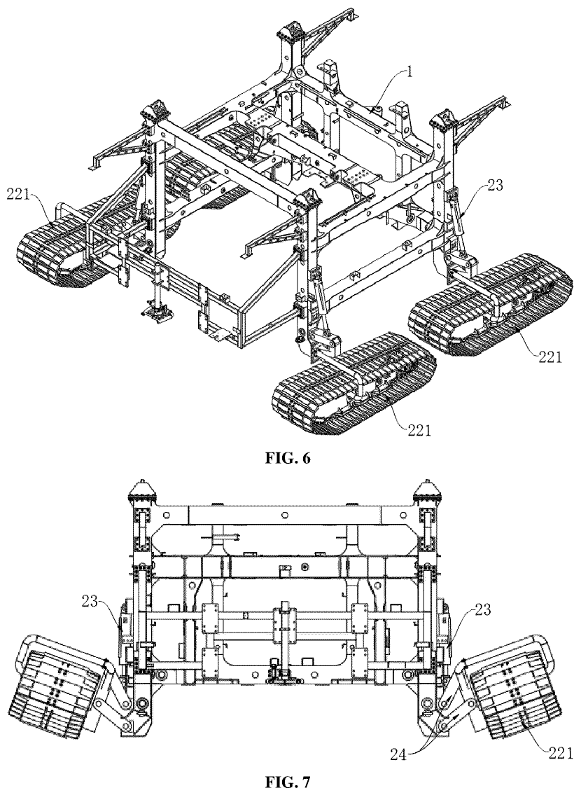

In the preferred implementation of the disclosure, as shown in FIGS. 6 to 7, a single track mechanism 22 includes two track modules 221, both of which are hinged with the main body 1 and have a moving stroke inclined relative to the main body 21, and a single track module 221 forms one track walking mechanism, that is, two track walking mechanisms described above are provided on each side of the main body 21 of the disclosure, and a specific structural principle of the above track walking mechanisms are the same as those in related art, which will not be described repeatedly herein. The single driving mechanism includes two first driving modules 23, and the two first driving modules 23 are configured to correspondingly drive the two track modules 221 to rotate around a hinge with the main body 1. In this implementation, there are totally four track modules 221 on both sides of the main body 1, and each of the four track modules 221 can be driven by a respective first driving module 23 to adjust its posture, and thus the four track modules 221 can have different inclination angles on rugged seabed to improve grasping ability and facilitate walking on seabed with large particles of rock.

The track module 221 is connected with the main body 1 through a linkage 24, and a posture of the track module 221 can be adjusted in cooperation with the first driving module 23, and compared with the track module 221 being directly driven to rotate by the rotating driving module, such adopted linkage structure facilitates improving of bearing capacity and reducing strength requirements for the first driving module 23. Specifically, the single track module 221 is connected with the main body 1 through two linkages 24, one end of each of the two linkages 24 is hinged with the main body 1, and the other end of each of the two linkages 24 is hinged with the track module 221, thus forming a quadrilateral mechanism. Because there are two linkages 24 for connecting the single track module 221 with the main body 1, it facilitates improving of structural strength and can disperse loads, and under same bearing capacity, load on a single linkage 24 is smaller, and requirements on strength and size of the linkage 24 are smaller. The first driving module 23 is a linear driving module, such as an oil cylinder or other driving modules with linear output. A cylinder end of the oil cylinder is hinged with the main body 21, and a piston end of the oil cylinder is hinged with one of the linkages.

The propulsion mechanism includes a vertical propeller 25 and a horizontal propeller 26, and the vertical propeller 25 and the horizontal propeller 26 are each arranged on the main body 1. As shown in FIG. 3, the vertical propeller 25 is a propeller arranged along a vertical direction of the main body 1, which is configured to generate a vertical thrust and assist in lifting and lowering of the operation system. The horizontal propeller 26 is a propeller arranged along a horizontal direction of the main body 1, which is configured to generate a horizontal thrust in a front-rear direction or a lateral direction of the operation system, and provide an auxiliary thrust for the operation system to move forward and backward or laterally, thus improving flexibility of underwater operation.

The propulsion mechanism further includes a rotatable propeller 27, the rotatable propeller 27 is arranged on the main body 1 and has a moving stroke inclined relative to the main body 1, so as to adjust inclination of the rotatable propeller 27, thereby adjusting a thrust direction. For example, when an original thrust of the operation system is not enough for a walking action in seabed with thin and soft soil or complex terrain, an additional horizontal or vertical thrust can be generated on a basis of a thrust from the original vertical propeller 25 or horizontal propeller 26 to increase the horizontal or vertical thrust and thus realize the walking action of the operation system. In this implementation, because a thrust direction of the rotatable propeller 27 is adjustable, a single rotatable propeller 27 can be used to increase the vertical thrust of the operation system or a horizontal thrust of the device, which has high flexibility in use, and can also reduce arrangement of a total number of propellers under a condition that the propellers have same power and same maximum vertical thrust and maximum horizontal thrust of the operation system. A second driving module 28 is further provided in the disclosure, the rotatable propeller 27 includes a connecting rod 271 and a propeller body 272 fixedly arranged on the connecting rod 271. The propeller body 272 moves and rotates along with the connecting rod 271, and the connecting rod 271 is hinged on the main body 1 and has a rotation stroke on the main body 1. The second driving module 28 is configured to drive the connecting rod 271 to rotate so as to adjust inclination of the rotatable propeller 27 relative to the main body 1, and thus adjust inclination of the rotatable propeller 27. The second driving module 28 is specifically an oil cylinder or other driving modules with linear output. The cylinder end of the oil cylinder is hinged with the main body 21, and the piston end of the oil cylinder is hinged with a side of the connecting rod 271. When the piston end of the oil cylinder extends out, the connecting rod 271 is pushed to rotate. Structural principles of the vertical propeller, the horizontal propeller and the propeller body are the same as those of the propeller in the related art, which will not be described repeatedly herein.

A cable locating module is further provided in the disclosure, the cable locating module is arranged on the main body 1 and located at a forwardmost end of the operation system, and has two sets of installation interfaces with different heights, a frame of the cable locating module is provided with two stages of oil cylinders, and a first stage of oil cylinder drives the frame of the cable locating module to rotate, and a second stage of oil cylinder changes a height of the cable locating module, so as to finally realize four laying heights of the cable locating module to be adapted to detection of different geology and cables with different diameters. The cable locating module is specifically an inductor using an electromagnetic induction cable, which is electrically connected with a control system of the operation system, and is configured to sense a position of the cable and transmit position information to the control system of the operation system. After determination and calculation, the control system automatically controls the propulsion mechanism and the walking mechanism to adjust an overall direction and speed of the operation system, so that the operation system can automatically follow a length direction of the cable to trench and lay the cable, thus reducing active intervention of operators and making a trenching and cable laying process more intelligent. The laying described in the disclosure is to lower a target mechanism to an operation posture.

The first laying mechanism includes a fixed pipeline 31, a rotating pipeline 32, a first driving mechanism 33 and a first driving mechanism 36. The fixed pipeline 31 is installed on the main body, and the rotating pipeline 32 is rotatably arranged on the fixed pipeline 31 and is communicated with the fixed pipeline 31, that is, the rotating pipeline 32 has a radial rotation stroke on the fixed pipeline 31, and the rotating pipeline 32 is kept in communication with the fixed pipeline 31 after being rotated. The first driving mechanism 33 is configured to drive the rotating pipeline 32 to rotate around the fixed pipeline 31. The first driving mechanism 33 is an oil cylinder, and a piston end of the oil cylinder is hinged with the rotating pipeline 32, while a cylinder end of the oil cylinder is hinged with the main body, thus forming a linkage-like structure, and realizing rotation of the rotating pipeline 32 while having better bearing capacity. Water inlet ends of the two jetting arms 34 are respectively fixedly provided with a guiding member 35, and a respective jetting arm 34 is communicated with a corresponding guiding member 35, and both guiding members 35 are rotatably arranged on and communicated with the rotating pipeline 32, that is, the two guiding members 35 each have a radial rotation stroke on the rotating pipeline 32, and the two guiding members 35 are kept in communication with the rotating pipeline 32 after being rotated, so that the two jetting arms 34 and the rotating pipeline are further kept in communication with each other. The second driving mechanism 36 is configured to drive the two jetting arms 34 and the two guiding members 35 to rotate around and on the rotating pipeline 32, and a number of the second driving mechanisms 36 corresponds to a number of the guiding members 35, which are both two. The second driving mechanism 36 is an oil cylinder, and a piston end of the oil cylinder is hinged with the guiding member 35, while a cylinder end of the oil cylinder is hinged with the main body, thus forming a linkage-like structure, and realizing rotation of the two guiding members 35 and the two jetting arms 34 while having better bearing capacity.

For the soil-breaking device provided in the disclosure, the fixed pipeline 31 and the rotating pipeline 32 are not only used as water supply pipelines for the two jetting arms 34, but also used as an installation and bearing structure of the two jetting arms 34. On a basis of realizing installation of the two jetting arms 34, there is no need to arrange additional pipelines meeting a lowering depth to connect the two jetting arms 34 with the water pump mechanism, so that communication with the jetting arms 34 can be ensured under a condition that the jetting arms 34 are at different lowering depths, which facilitates simplifying of an overall structure, reduces an overall volume, and reduces space occupation. Compared with general pipes, the fixed pipeline 31 and the rotating pipeline 32 are used as the installation and bearing structure of the two jetting arms 34, which have greater strength and hardness, and when used as the water supply pipelines, the fixed pipeline 31 and the rotating pipeline 32 are not easy to leak due to impact of underwater creatures or rocks, thus with higher reliability. A two-stage drive structure is formed by the first drive mechanism 33 and the second drive mechanism 36, so that not only can the two jetting arms 34 be lowered and recovered, but also the second drive mechanism 36 can synchronously drive the two jetting arms 34 to rotate to adjust their postures when the first driving mechanism 33 is used to drive the rotating pipeline 32 to turn over to lower the two jetting arms 34; and when the two jetting arms 34 are lowered deeper or shallower, an angle of the front nozzle relative to a vertical direction can be kept in an optimal jetting angle range, thus ensuring a spraying angle of the water jet to be an optimal angle for jetting and soil-breaking, so that the disclosure can be applied to trenching operations at different depths, while trenching quality and efficiency are ensured, with high flexibility of underwater operations.

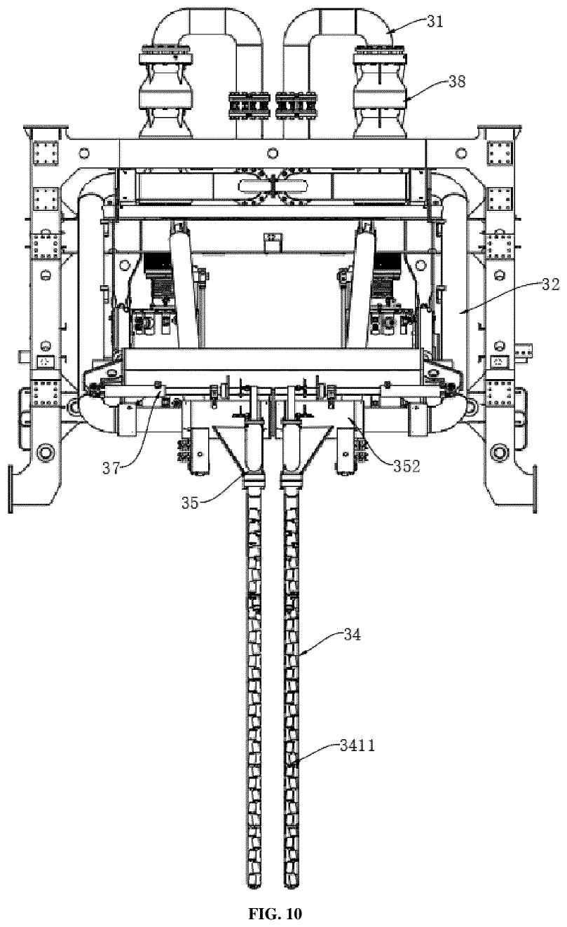

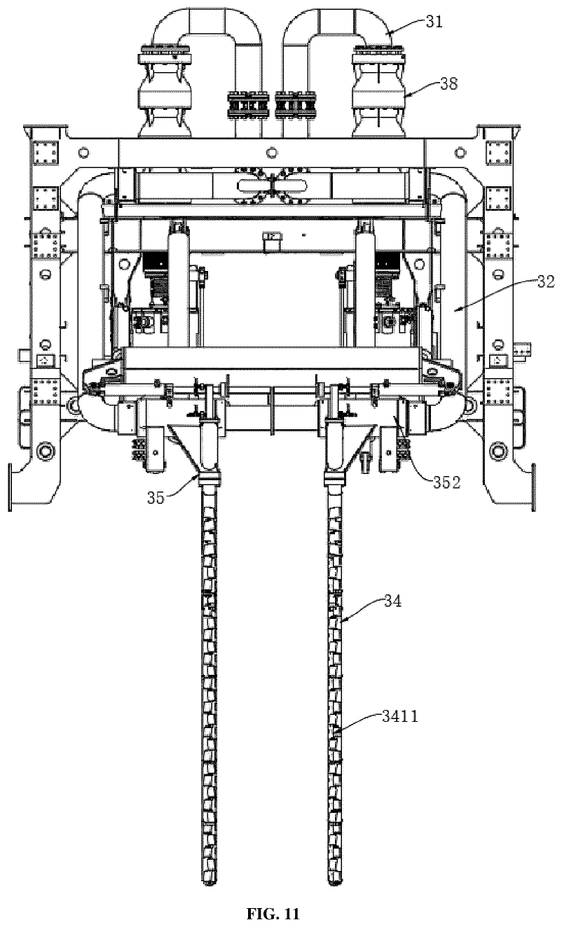

As shown in FIG. 9, a posture after the two jetting arms 34 are completely lowered, that is, a posture in which the two jetting arms are lowered to a lowest position, is illustrated, which can be applied to trenching operation for deep trenches. As shown in FIG. 10, a posture in which the two jetting arms 34 are lowered at a shallow depth is illustrated, which can be applied to trenching operation for shallow trenches. In these two postures, orientations and angles relative to the vertical direction of the front nozzle are the same.

In an embodiment of the disclosure, the fixed pipeline 31 and the rotating pipeline 32 can be communicated with each other through a flexible pipe, so as to ensure communication on a basis of providing a rotation stroke of the rotating pipeline 32. The rotating pipeline 32 is communicated with the two guiding members 35 through flexible pipelines, so as to ensure communication on a basis of providing moving strokes of the two guiding members 35.

In a preferred embodiment of the disclosure, a radial dynamic seal is provided at a rotational fit between the rotating pipeline 32 and the fixed pipeline 31, so that the rotating pipeline 32 and the fixed pipeline 31 can be directly communicated with each other on a basis of providing a rotation stroke. A radial dynamic seal is further provided at rotational fits between the two guiding members 35 and the rotating pipeline 32, so that the two guiding members 35 can be directly communicated with the rotating pipeline 32 on a basis of provided a rotating stroke. In this embodiment, there is no need to add additional flexible pipes, which reduces complexity of pipelines and a risk of damage and water leakage at junctions.

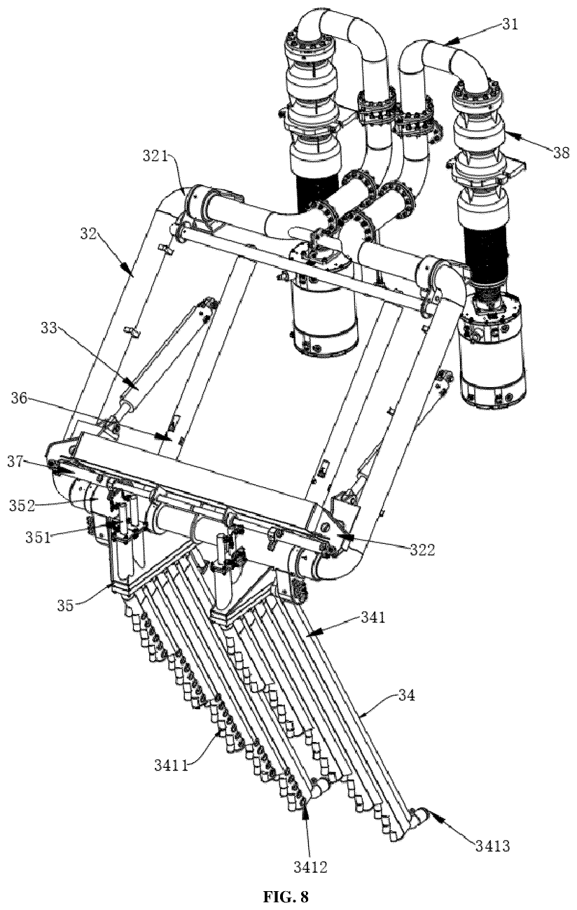

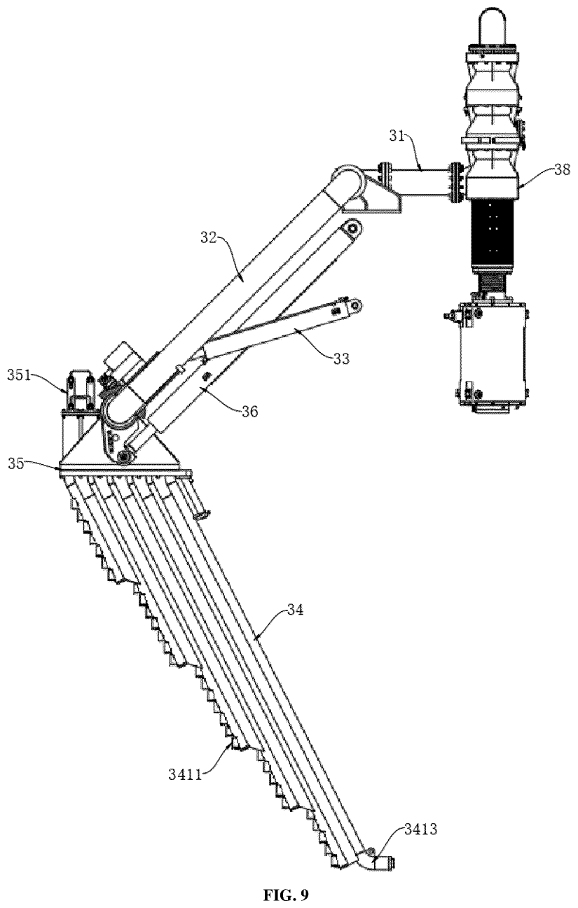

There are two groups of fixed pipelines 31, and the two groups of fixed pipelines 31 are respectively connected with a set of water pump mechanisms 38, that is, the two groups of fixed pipelines 31 realize water supply through respective water pump mechanisms 38. The rotating pipeline 32 is in a shape of a right-angled U. As shown in FIG. 8, two ends of the rotating pipeline 32 are each provided with an elbow 321, and the two groups of fixed pipelines 31 are arranged to be transversely bent. The elbows 321 at the two ends of the rotating pipeline 32 are rotationally connected with transverse parts of the two groups of fixed pipelines 31 and are radially and dynamically sealed for direct communication. On a basis of ensuring communication, the rotating pipeline 32 as a whole can rotate around and on the two groups of fixed pipelines 31 under action of the first driving mechanism 33. In addition, the two groups of fixed pipelines 31 are communicated with each other through a branch pipe and/or the two ends of the rotating pipeline 32 are communicated with each other through a branch pipe. When one of the two groups of water pump mechanisms 38 malfunctions or fails, water supply of the two jetting arms 34 can be maintained through the other of the two groups of water pump mechanisms 38, so that the operation can be maintained and interruption can be avoided. A connecting sleeve 352 is fixedly provided at an upper end of the guiding member 35. As shown in FIG. 8, connecting sleeves 352 of the two guiding members 35 are each sleeved on the rotating pipeline 32, that is, the guiding member 35 is connected with the rotating pipeline 32 through the connecting sleeve 352. In an embodiment where the guiding member 35 and the rotating pipeline 32 are dynamically sealed, the guiding member 35 is communicated with the connecting sleeve 352, and the guiding member 35, specifically the connecting sleeve 352, is dynamically sealed with the rotating pipeline 32. Moreover, a side wall of the rotating pipeline 32 at an overlapping position with the connecting sleeve 352 is provided with a water passage hole, and a water flow in the rotating pipeline 32 enters the guiding member 35 along the connecting sleeve 352 through the water passage hole, and flows from the guiding member 35 into the jetting arm 34 along the water inlet end of the jetting arm 34.

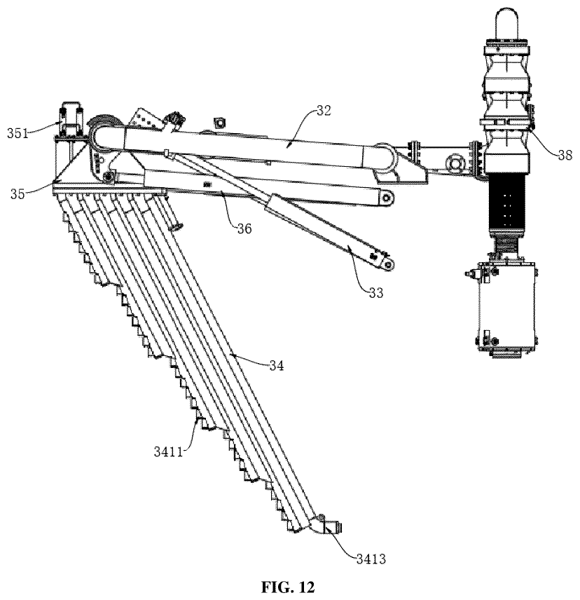

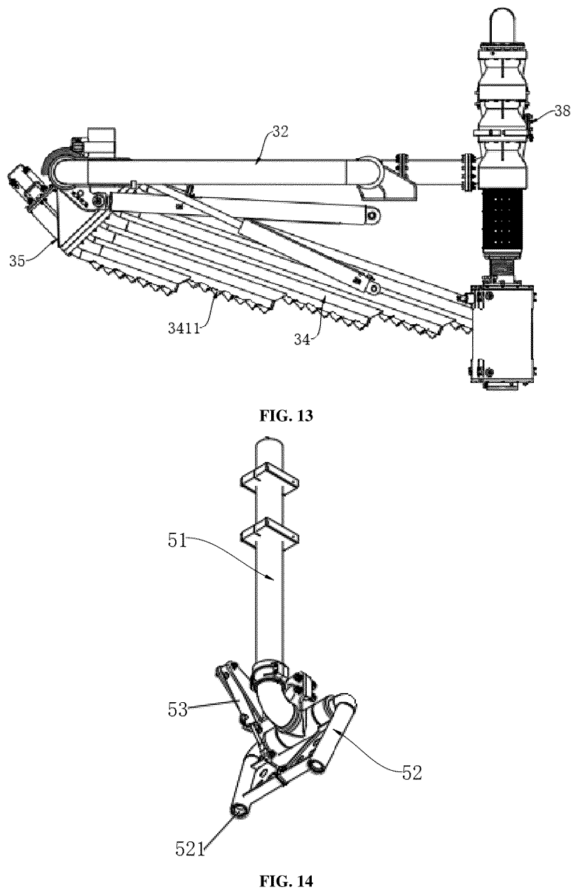

There are several front nozzles 3411 on a single jetting arm 34, and the front nozzles 3411 are arranged along a height direction of the jetting arm 34. Specifically, the single jetting arm 34 includes several groups of first jetting pipes 341 with different lengths, which are arranged side by side in an order of length, that is, arranged in parallel in an order from short to long, and the groups of first jetting pipes 341 are all communicated with the guiding member 35 and are all provided with the front nozzle 3411. As shown in FIGS. 12 and 13, the front nozzle 3411 of a first jetting pipe 341 with a shortest length among the groups of first jetting pipes 341 is arranged on a side of the first jetting pipe 341 away from the other first jetting pipes 341, and the front nozzles 3411 of other first jetting pipes 341 are arranged in an area beyond adjacent first jetting pipes 341, and the front nozzles 3411 on all of the first jetting pipes 341 are arranged in a same direction, and as shown in FIGS. 10 and 11, in a front view of the jetting arm 34, the front nozzles 3411 on the groups of first jetting pipes 341 are arranged along a height direction of the jetting arm 34.

The guiding member 35 is provided with a guiding plug 351 for blocking or opening a part of first jetting pipes 341 at a short-length side among the groups of first jetting pipes 341. Because the groups of first jetting pipes 341 are arranged side by side in the order of length, the short-length side is specifically a side where a shortest first jetting pipe 341 in the jetting arm 34 is located, a number of first jetting pipes 341 that can be blocked or opened by the guiding plug 351 in the single jetting arm 34 is less than a number of all of first jetting pipes 341 in the jetting arm 34. When there are at least two groups of first jetting pipes 341 that can be blocked or opened by the guiding plug 351, the at least two groups of first jetting pipes 341 are at least two groups of first jetting pipes 341 in sequence from the shortest first jetting pipe 341 along a length direction. When a trench to be opened is deep, the jetting arm 34 is deeply submerged in the seabed. As shown in FIG. 1, all of the first jetting pipes 341 are submerged in the seabed, and all of the front nozzles 3411 are substantially not higher than the seabed, that is, all of the front nozzles 3411 participate in soil-breaking and trenching operation on the seabed. When the trench to be opened is shallow, as shown in FIG. 2, a depth of the jetting arm 34 submerged in the seabed is shallow, and at this time, a part of the front nozzles 3411 may be significantly higher than the seabed and may not participate in the soil-breaking and trenching operation on the seabed, and the first jetting pipes 341 where these front nozzles 3411 are located are blocked by the guiding plug 351, so that the first jetting pipes 341 located above the seabed spray no jet, and all of water flows can be guided into the first jetting pipes 341 located in the seabed, thus improving utilization efficiency of water jet and trenching efficiency. A position of the guiding plug 351 on the guiding member 35 is located above the first jetting pipes 341. The guiding plug 351 specifically includes a fourth driving mechanism and a plug body. The fourth driving mechanism is preferably an oil cylinder, a cylinder end of which is fixedly arranged on the guiding member 35, and the plug body is arranged on a piston end of the oil cylinder. The plug body penetrates through inside the guiding member 35 and is dynamically sealed with the guiding member 35, and the plug body is driven by the oil cylinder to move towards the first jetting pipe 341 and inserted into the first jetting pipe 341 to realize blocking, and the plug body is driven by the oil cylinder to move away from the first jetting pipe 341 to realize opening.

The operation system further includes a third driving mechanism 37, the third driving mechanism 37 can drive the guiding member 35 to move axially along the rotating pipeline 32 to adjust a distance between the two jetting arms 34, so as to be suitable for opening trenches with different widths. An axial moving stroke of the guiding member 35 generated on the rotating pipeline 32 is an axial moving stroke of the connecting sleeve 352 on the rotating pipeline 32. In the embodiment of the disclosure based on dynamic sealing, dynamic sealing between the connecting sleeve 352 and the rotating pipeline 32 on the guiding member 35 further includes axial dynamic sealing, that is, the guiding member 35 also has an axial moving stroke on the rotating pipeline 32. When the connecting sleeve 352 moves axially on the rotating pipeline 32, the water passage hole is always located in an overlapping range of the connecting sleeve 352 and the rotating pipeline. In the embodiment of the disclosure based on flexible pipe connection, a length of the flexible pipe only needs to meet the moving stroke of the guiding member 35. After the distance between the two jetting arms 34 is adjusted, the two jetting arms 34 can be kept in communication with the rotating pipeline 32 through the guiding member 35. The third driving mechanism 37 is an oil cylinder, which is connected between the two guiding members 35 to drive the two guiding members 35 to move synchronously. Alternatively, there are two oil cylinders, and a mounting rod 322 is fixedly arranged on the rotating pipeline 32, cylinder ends of the two oil cylinders are fixed on an installation rod 322, and piston ends of the two oil cylinders are correspondingly connected with the two guiding members 35.

An inner nozzle 3412 is provided on each of several groups of first jetting pipes 341 of the two jetting arms 34. The inner nozzle 3412 of a first jetting pipe 341 with a shorted length among the groups of first jetting pipes 341 is located at an inner side of the first jetting pipe 341, and front nozzles 3411 on remaining first jetting pipes 341 are arranged at an inner side of an area beyond adjacent first jetting pipes 341, and the inner nozzles 3412 of the two jetting arms 34 are arranged opposite to each other. When the trench to be opened is wide, a distance between the two jetting arms 34 is large, and soil in a middle of the trench may not be liquefied. Provision of the inner nozzle 3412 can form opposite water jets in the trench in a width direction of the trench, so that soil between the two jetting arms 34 can be liquefied, which facilitate opening a trench with a large width according to a large-diameter cable 100 and ensuring the shape of the trench with the large width, further improving flexibility of use.

Bottoms of the two jetting arms 34 are each provided with a tail nozzle 3413, and a jetting direction of the tail nozzle 3413 is set away from a jetting direction of the front nozzle 3411, that is, the jet direction of the tail nozzle 3413 is away from the jet direction of the front nozzle 3411, and a jet sprayed by the tail nozzle 3413 is parallel to the bottom of the trench. With provision of the tail nozzle 3413, after the front nozzle 3411 opens the trench, a high-pressure water flow in the jetting arm 34 can used to generate a horizontal jet in the trench opposite to the front nozzle 3411, continuously liquefy soil in a rear of the trench, maintain the shape of the trench, reduce backfilling of sediment before operation of the two jetting suction assemblies, and reduce suction intensity and requirements for water pressure of the two jetting suction assemblies. Especially when the seabed has soil with high fineness and softness and a distance between the two jetting suction assemblies and the two jetting arms 34 is large due to a large bending radius of the cable, the tail nozzle 3413 can be arranged to cooperate with the two jetting suction assemblies to better ensure the shape and depth of the trench before the cable completely settles. Preferably, the tail nozzle 3413 is arranged at a bottom of a first jetting pipes 341 with a longest length in the jetting arm 34, so that the tail nozzle 3413 can be kept at the bottom of the trench when different depths of the trenches are opened.

As shown in FIG. 14, the operation system further includes a lead jetting mechanism 5, the lead jetting mechanism 5 is arranged on the main body 1 and located between the two jetting arms 4. The lead jetting mechanism 5 can be arranged to function in pre-jetting before the jetting arm 34 performs jetting and soil-breaking. On one hand, the lead jetting mechanism can be used to clean up silt and gravel on a surface of the seabed and on the cable and attachment of seabed organisms. On the other hand, the lead jetting mechanism can be used to open a shallow trench on the surface of the seabed before the jetting arm 34 to form a pre-trench, which can reduce difficulty of the jetting arm 34 in soil-breaking and trenching when turning, and facilitate trenching and cable burying operation with turning. The lead jetting mechanism 5 includes a support pipe 51, a lead jetting pipe 52 and a fifth driving mechanism 53. The support pipe 51 is connected with an external water supply unit, the lead jetting pipe 52 is rotatably arranged at a lower end of the support pipe 51 and is dynamically sealed; a lower end of the lead jetting pipe 52 is provided with a lead nozzle 521 for spraying a water jet; and the fifth driving mechanism 53 is specifically an oil cylinder, which is hinged between the support pipe 51 and the lead jetting pipe 52. Specifically, as shown in FIG. 14, there are two lead jetting pipes 52, the two lead jetting pipes 52 are each bent and an end of each of the two lead jetting pipes 52 away from the lead nozzle 521 is rotationally connected and dynamically sealed with a lower end of the support pipe 51. The two lead jetting pipes 52 together form a U-shaped nozzle structure, and the two lead jetting pipes 52 are fixedly connected with each other through a rod body, and the oil cylinder is specifically hinged between the support pipe 51 and the rod body.

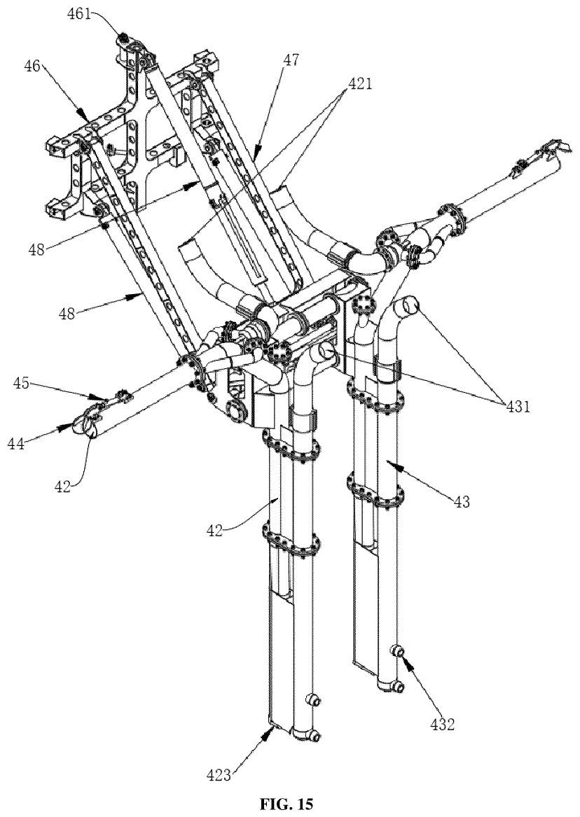

As shown in FIGS. 15 to 19, the jetting suction device 4 further includes a second laying mechanism, a support seat 41 and a first driving assembly 44. The second laying mechanism is arranged at the rear end of the main body 1, the support seat 41 is arranged at an end of the second laying mechanism away from the main body 1, a single one of the second jetting pipes 43 is fixedly connected with a single suction pipeline 42, and two jetting suction assemblies are arranged at an end of the second laying mechanism away from the main body 1 through the support seat 41. The two jetting suction assemblies are arranged at an interval for the cable to pass through, and in an operation state, the cable can fall into the trench along a space between the two jetting suction assemblies. This implementation can serve to suck and discharge the sediment inside the trench and continuously liquefy the soil without affecting normal settlement of the cable. A lower end of the second jetting pipe 43 is arranged in parallel with a lower end of the suction pipeline 42, and a side of the second jetting pipe 43 is provided with the jetting port 432, and the jetting port 432 is specifically located on a side of the second jetting pipe 43 away from the two jetting arms, and a jetting direction of the jetting port 432 is perpendicular to a suction direction of the suction port 423. When the jetting suction device 4 operates, the two jetting suction assemblies are used at the same time, the suction port 423 and the jetting port 432 are both located in the trench. The suction port 423 is arranged towards an inner bottom surface of the trench, and the jetting direction of the jetting port 432 is arranged along the length direction of the trench, that is, the jetting direction is towards a right direction in FIGS. 1 and 2. When the suction port 432 is located in the trench, the suction port 432 sprays a horizontal jet in a direction away from the two jetting arms along the length direction of the trench.

When a bending radius of the cable is large or a depth of the trench is large, it is preferable that the second laying mechanism is arranged to extend in a direction away from the main body 1, so as to increase the distance between the two jetting suction assemblies and the two jetting arms and mitigate an amplitude of the cable from the seabed to the bottom of the trench. At least one of the two jetting suction assemblies is slidably arranged on the support seat 41, and the first driving assembly 44 drives the slidably arranged jetting suction assembly to move so as to adjust a distance between the two jetting suction assemblies to be adapted to trenches with different widths.

A pipe diameter contraction section is provided on the suction pipeline 42 between a first water inlet 421 and the suction port 423, and a side surface of the pipe diameter contraction section is communicated with the suction port 423. Specifically, a middle part of the suction pipeline 42 between the first water inlet 421 and the suction port 423 is arranged to be contracted to form the pipe diameter contraction section, and the side surface of the pipe diameter contraction section is longitudinally communicated with an extension pipe to form a lower end of the suction pipeline 42, an end of the extension pipe is the suction port 423, and with Venturi effect, when the water flows rapidly along the first water inlet 21 to the discharge port 22, a low pressure is generated at the suction port 23, thereby generating adsorption. Water pumps are respectively arranged on the suction pipeline 42 and the second jetting pipe 43, for respectively driving the water flow along a direction from the first water inlet 421 to the discharge port 422 and driving the water flow along a direction from the second water inlet 431 to the jetting port 432. A position of the water pump on the suction pipeline 42 is arranged at the first water inlet 421, so as to ensure that water flows along the direction from the first water inlet 421 to the discharge port 422, and a position of the water pump on the second jetting pipe 43 is arranged at the second water inlet 431, or at other positions of the second jetting pipe 43, so as to ensure that water flows along the direction from the second water inlet 431 to the jetting port 432.

The jetting suction device further includes the support seat 41 and the first driving assembly 44, the two jetting suction assemblies are arranged at an end of the second laying mechanism away from the main body 1 through the support seat 41, and at least one of the two jetting suction assemblies is slidably arranged on the support seat 41, and the first driving assembly 44 drives the slidably arranged jetting suction assembly to move so as to adjust a distance between the two jetting suction assemblies to be adapted to trenches with different widths.

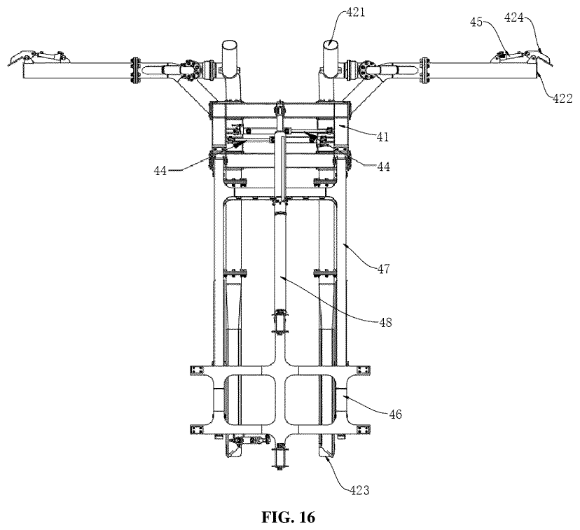

Preferably, the two jetting suction assemblies are each slidably arranged on the support base 1, and the first driving assembly 44 is located between the two jetting suction assemblies. A fixed end of the first driving assembly 44 is connected with one of the two jetting suction assemblies, and a moving end of the first driving assembly is connected with the other of the two jetting suction assemblies, so as to ensure symmetry of the two jetting suction assemblies on the support base 1, and a moving stroke of a single jetting suction assembly is smaller under same distance adjustment. Specifically, the suction pipes 42 in the two jetting suction assemblies are each connected with the support base 41 in a sliding way through sliders, and the first driving assembly 44 is an oil cylinder, a cylinder end of the oil cylinder is fixed with the suction pipe 42 in one of the two jetting suction assemblies, and a piston end of the oil cylinder is fixed with the suction pipe 42 in the other of the two jetting suction assemblies. As shown in FIG. 16, there are two first driving assemblies 44 provided.

One end of the suction pipeline 42 is provided with a water inlet, the other end of the suction pipeline is transversely arranged, and the discharge port 422 is located at the transversely arranged end; a pipe diameter contraction section is provided between the first water inlet 421 and the discharge port 422 on the suction pipeline 42, an extension pipe is longitudinally extended on a side surface of the pipe diameter contraction section, the suction port 423 is located on the extension pipe, and with Venturi effect, when the water flows rapidly along the first water inlet 421 to the discharge port 422, a low pressure is generated at the suction port 423, thereby generating adsorption. Water pumps are respectively arranged on the suction pipeline 42 and the second jetting pipe 43, for respectively driving the water flow along a direction from the first water inlet 421 to the discharge port 422 and driving the water flow along a direction from the second water inlet 431 to the jetting port 432. A position of the water pump on the suction pipeline 42 is arranged at the first water inlet 421, so as to ensure that water flows along the direction from the first water inlet 421 to the discharge port 422, and a position of the water pump on the second jetting pipe 43 is arranged at the second water inlet 431, or at other positions of the second jetting pipe 43, so as to ensure that water flows along the direction from the second water inlet 431 to the jetting port 432.

The suction pipeline 42 is provided with an end cover 424 at the discharge port 422, and an opening and closing degree between the end cover 424 and the discharge port 422 is adjustable so as to adjust a water flow of the discharge port 422 according to operation situation. When the suction port 423 is blocked by mud, the discharge port 422 is closed by the end cover 424. At this time, the water flow direction is along a direction from the first water inlet 421 to the suction port 423, so that the suction port 423 can be flushed reversely to clear blockage.

The operation system further includes a second driving assembly 45, by which the end cover 424 is driven to move or rotate, so as to adjust the opening and closing degree between the end cover 424 and the discharge port 422. The end cover 424 is hinged at an end of the discharge port 422 of the suction pipeline 42. The second driving assembly 45 is an oil cylinder, a cylinder end of the oil cylinder is hinged with the suction pipeline 42, and a piston end of the oil cylinder is hinged with a side of the end cover 424. Opening and closing of the end cover 424 is driven by expansion and contraction of a piston of the oil cylinder.

The operation system further includes a third driving assembly 48, and the support seat 41 is driven to lift by the third driving assembly 48, so as to realize recovery, lowering, and lower height adjustment of the two jetting suction assemblies, so as to be suitable for trenches with different depths.

The operation system further includes a fixed frame 46 and a movable frame 47. The fixed frame 46 is connected with the main body 1, one end of the moving frame 47 is hinged with the fixed frame 46, and the other end of the moving frame is hinged with the support seat 41, and the third driving assembly 48 is hinged between the fixed frame 46 and the support seat 41 to form a linkage mechanism. With this implementation, on the one hand, laying, recovery and adjustment of a lowering height of the two jetting suction assemblies can be realized, and in combination with the two jetting arms 34 with the adjustable lowering height, opening of trenches with different depths and laying of the cable 100 can be realized. As shown in FIG. 1, the two jetting arms 34 and two jetting suction assemblies are lowered deeply, and at this time the opened trench is deep; as shown in FIG. 2, the two jetting arms 34 and two jetting suction assemblies are lowered shallowly, and at this time the opened trench is shallow, so as to ensure effective and reliable laying of the cable 100 for deep and shallow trenches. On the other hand, compared with the directly arranged vertical linear drive mechanism, the linkage mechanism is used to drive the two jetting suction assemblies to be recovered and lowered, so that with same recovery and lowering strokes, too much height space may not be occupied, and it is convenient to carry other tools on the main body 1 and reduce interference between tools.

The third driving assembly 48 is an oil cylinder, a cylinder end of the oil cylinder is hinged with the fixed frame 46, and a piston end of the oil cylinder is hinged with the support seat 41, and there can be two third driving assembly 48 with arrangement shown in FIGS. 15, 17 and 19.

The operation system further includes a fourth driving assembly 49, the fixed frame 46 is provided with a hinge part 461, and the fixed frame 46 is hinged with the main body 1 through the hinge part 461, and a hinge axis is arranged along a lifting direction of the support seat 41, that is, vertically. The fourth driving assembly 49 is configured to drive the fixed frame 46 to rotate around the hinge part on the main body 1, so as to realize left swing and right swing of the whole device, that is, as shown in FIGS. 5 and 6, so as to be adapted to a turning area or trenching in a curve. The fourth driving assembly 49 is specifically an oil cylinder, a cylinder end of the oil cylinder is hinged with the fixed frame 6, and a piston end of the oil cylinder is hinged with the main body 1, and the left swing and the right swing of the whole device are driven by expansion and contraction of the piston end so as to cooperate with a turning action of the operation system.

An operation method for underwater jet trenching and cable laying is provided in the disclosure, which uses the operation system for underwater jet trenching and cable laying and includes:
S1, enabling the operation system for underwater jet trenching and cable laying to settle on seabed to be trenched and buried with a cable, and enabling projections of the two jetting arms 34 on the seabed to be positioned at two sides of the cable correspondingly, that is, in which in a height direction, positions of the two jetting arms 34 and the cable 100 are not overlapped with each other, so as to avoid crushing the cable 100 when the jetting arms 34 are lowered and trenching operation is performed;
S2, lowering the two jetting arms 34 downwards, spraying jets using the front nozzles 3411 on the two jetting arms, walking the operation system for underwater jet trenching and cable laying on the seabed along a length direction of the cable 100 through the underwater walking device 2, so as to jet and soil-break the seabed along the length direction of the cable 100 to trench, while spraying jets by the tail nozzle 3413 away from a direction where the front nozzle 3411 is located, so as to continuously liquefy soil in the trench, maintain a shape and depth of the trench, and reduce sediment backfill and collapse on two sides of the trench;
S3, lowering the jetting suction device 4 so that the two jetting suction assemblies extend into the trench, and sucking sediment in the trench through the suction port 423 of the suction pipeline 42 before the cable falls into the trench, and discharging the sediment to outside of the trench through the discharge port 422 so as to ensure that the depth of the trench meets operation requirements, spraying a horizontal jet in the trench in a direction away from the two jetting arms 34 through the jetting port 432 to continuously liquefy soil in the trench, and settling the cable 100 naturally to the bottom of the trench along a space between the two jetting suction assemblies.

Because the jet from the jetting port 432 only needs to maintain the shape of the trench and does not need to additionally function in soil-breaking, a water pressure required by the jet from the jetting port 432 is less than a water pressure of the jet from the front nozzle 3411, that is, in S3, the water pressure of the jet from the jetting port 432 is less than the water pressure of the jet from the front nozzle 3411.

It should be understood by those of ordinary skilled in the art that discussion of any of the above embodiments is only exemplary, and is not intended to imply that the protection scope of the disclosure is limited to these examples; under the concept of this disclosure, the technical features in the above embodiments or different embodiments can also be combined, and the steps can be realized in any order; and there are many other changes in different aspects of one or more embodiments of this disclosure as described above, which are not provided in details for brevity.

One or more embodiment of this disclosure are intended to cover all such alternatives, modifications and variations that fall within that broad scope of the disclosure. Therefore, any omissions, modifications, equivalent substitutions, improvements, etc. made within the spirit and principles of one or more embodiments of this disclosure shall be encompassed within the protection scope of this disclosure.

What is claimed is

1. An operation system for underwater jet trenching and cable laying, comprising:
a main body (1);
a underwater walking device (2) provided at a lower end of the main body (1);
a jetting soil-breaking device (3) comprising two jetting arms (34), the two jetting arms (34) being located at a front end of the main body (1) and are each provided with a front nozzle (3411) for spraying a jet to trench on seabed; and
a jetting suction device (4) arranged at a rear end of the main body (1) and comprising a suction pipeline (42) and a second jetting pipe (43), the suction pipeline (42) is provided with a discharge port (422) and a suction port (423), and the suction port (423) is configured to be towards a bottom of a trench, and a position of the discharge port (422) is higher than a position of the suction port (423) and the discharge port (422) is transversely arranged relative to the suction port (423), and the suction pipeline (42) is configured to suck sediment in the trench through the suction port (423) before a cable settles to the bottom of the trench, and to discharge the sediment to outside of the trench through the discharge port (423); wherein
the second jetting pipe (43) is located at a rear side of the suction pipeline (42), and is provided with a jetting port (432), a jetting direction of jetting port (432) is horizontally arranged in a direction away from the suction pipeline (42), and the second jetting pipe (43) is configured to spray a horizontal jet through the jetting port (432) to scour an inner side wall and the bottom of the trench along the length direction of the trench after the sediment in the trench is sucked by the suction pipeline (42), so as to maintain a shape of the trench when the cable settles to the bottom of the trench.

2. The operation system for underwater jet trenching and cable laying according to claim 1, wherein the jetting soil-breaking device (3) further comprises a first laying mechanism, wherein the first laying mechanism comprises a fixed pipeline (31), a rotating pipeline (32), a first driving mechanism (33) and a second driving mechanism (36), the fixed pipeline (31) is fixed with the main body (1), and the rotating pipeline (32) is rotatably arranged on and communicated with the fixed pipeline (31), the first driving mechanism (33) is configured to drive the rotating pipeline (32) to rotate around the fixed pipeline (31), the two spraying arms (34) are rotatably arranged on and communicated with the rotating pipeline (32); and the second driving mechanism (36) is configured to drive the two spraying arms (34) to rotate around the rotating pipeline (32).

3. The operation system for underwater jet trenching and cable laying according to claim 2, wherein the jetting soil-breaking device (3) further comprises a third driving mechanism (37), and the third driving mechanism (37) is capable of driving the two jetting arms (34) to move along an axial direction of the rotating pipeline (32) to adjust a distance between the two jetting arms (34).

4. The operation system for underwater jet trenching and cable laying according to claim 2, wherein there are two suction pipelines (42) arranged at an interval along a width direction of the main body (1), and a distance between the two suction pipelines (42) is adjustable, and there are two second jetting pipes (43) arranged at an interval along the width direction of the main body (1), and a distance between the two jetting pipes (43) is adjustable.

5. The operation system for underwater jet trenching and cable laying according to claim 4, wherein the jetting suction device (4) further comprises a second laying mechanism, a support seat (41) and a first driving assembly (44), wherein the second laying mechanism is arranged at the rear end of the main body (1), the support seat (41) is arranged at an end of the second laying mechanism away from the main body (1), a single one of the second jetting pipes (43) is fixedly connected with a single suction pipeline (42), and the single one of the second jetting pipes (43) and the suction pipeline (42) fixedly connected therewith form a jetting suction assembly, two jetting suction assemblies are arranged on the support seat (41) and are arranged at an interval, and the cable is capable of falling into the trench along a space between the two jetting suction assemblies; and
at least one of the two jetting suction assemblies is slidably arranged on the support seat (41), and the first driving assembly (44) drives the slidably arranged jetting suction assembly to move so as to adjust a distance between the two jetting suction assemblies.

6. The operation system for underwater jet trenching and cable laying according to claim 5, wherein bottoms of the two jetting arms (34) are each provided with a tail nozzle (3413), and a jetting direction of the tail nozzle (3413) is set away from a jetting direction of the front nozzle (3411).

7. The operation system for underwater jet trenching and cable laying according to claim 5, wherein laying heights of the two jetting arms (34) and the two jetting suction assemblies are adjustable.

8. The operation system for underwater jet trenching and cable laying according to claim 1, wherein one end of the suction pipeline (42) is provided with a first water inlet (421), the other end of the suction pipeline (42) is transversely arranged, and the discharge port (422) is located at the transversely arranged end; a pipe diameter contraction section is provided between the first water inlet (421) and the discharge port (422) on the suction pipeline (42), an extension pipe is longitudinally extended on a side surface of the pipe diameter contraction section, the suction port (423) is located on the extension pipe; an end cover (424) is provided on the suction pipeline (42) at a position of the discharge port (422); and an opening and closing degree between the end cover (424) and the discharge port (422) is adjustable.

9. The operation system for underwater jet trenching and cable laying according to claim 1, further comprising a lead jetting mechanism (5), wherein the lead jetting mechanism (5) is arranged at the front end of the main body (1) and in front of the two jetting arms (34), and the lead jetting mechanism (5) is provided with a lead nozzle (51) to purge and/or pre-trench the seabed before the two jetting arms (34) operate.

10. An operation method for underwater jet trenching and cable laying using the operation system for underwater jet trenching and cable laying according to claim 1, comprising:
S1, enabling the operation system for underwater jet trenching and cable laying to settle on seabed to be trenched and buried with a cable, and enabling projections of the two jetting arms (34) on the seabed to be positioned at two sides of the cable (100) correspondingly;
S2, walking the operation system for underwater jet trenching and cable laying on the seabed along a length direction of the cable (100) through the underwater walking device (2), and spraying jets through front nozzles (3411) on the two jetting arms (34) to jet and soil-break the seabed along the length direction of the cable (100) to trench; and
S3, sucking the sediment in the trench through the suction port (423) of the suction pipeline (42) before the cable falls into the trench, and discharging the sediment to outside of the trench through the discharge port (423), and spraying a horizontal jet through the jetting port (432) to scour an inner side wall and a bottom of the trench along a length direction of the trench, so as to continuously liquefy soil in the trench and maintain a shape of the trench, and settling the cable (100) naturally to the bottom of the trench.
